(19) United States
(12) Patent Application Publication
(10) Pub. No.: US 2026/0099955 A1
(43) Pub. Date: Apr. 9, 2026

(54) ELIMINATION OF OVER-SATURATION EFFECTS OF GENERATIVE MODELS

(71) Applicants: Disney Enterprises, Inc., Burbank, CA (US); ETH Zürich (Eidgenössische Technische Hochschule Zürich), Zürich (CH)

(72) Inventors: Seyedmorteza Sadat, Dübendorf (CH); Romann Matthew Weber, Uster (CH)

(73) Assignees: Disney Enterprises, Inc., Burbank, CA (US); ETH Zürich (Eidgenössische Technische Hochschule Zürich), Zürich (CH)

(21) Appl. No.: 19/066,944

(22) Filed: Feb. 28, 2025

Related U.S. Application Data
(60) Provisional application No. 63/703,064, filed on Oct. 3, 2024.

(51) Int. Cl. G06T 11/00; G06T 5/70

(52) U.S. Cl. CPC G06T 11/00; G06T 5/70

(57) ABSTRACT

In some embodiments, a generative model determines a conditional output and an unconditional output for denoising a noisy sample. An update direction is determined based on the conditional output and the unconditional output. The method decomposes the update direction into a first component and a second component. One or more of the first component and the second component is weighted to generate a weighted update direction. The weighted update direction is based on reducing a strength of the second component. The method determines a denoised output based on the conditional output and the weighted update direction. The denoised output is used to generate a generative output by the generative model.

### CROSS REFERENCE TO RELATED APPLICATIONS

Pursuant to 35 U.S.C. § 119(e), this application is entitled to and claims the benefit of the filing date of U.S. Provisional App. No. 63/703,064 filed Oct. 3, 2024, entitled “ELIMINATING OVER-SATURATION EFFECTS OF DIFFUSION MODELS AT HIGH GUIDANCE SCALES”, the content of which is incorporated herein by reference in its entirety for all purposes.

### BACKGROUND

Classifier-free guidance (CFG) is a technique for boosting the quality of output from diffusion models that rely on input prompts. Classifier-free guidance suffers from several well-known drawbacks. One of these is that at high guidance scales, which are required to enforce fidelity to the input prompt, the resulting output is often highly saturated, creating an unrealistic final image.

### BRIEF DESCRIPTION OF THE DRAWINGS

The included drawings are for illustrative purposes and serve only to provide examples of possible structures and operations for the disclosed inventive systems, apparatus, methods, and computer program products. These drawings in no way limit any changes in form and detail that may be made by one skilled in the art without departing from the spirit and scope of the disclosed implementations.

FIG. 1 depicts a simplified system for performing adaptive projected guidance according to some embodiments.

FIG. 2 depicts a simplified flowchart of a method for performing adaptive projected guidance according to some embodiments.

FIG. 3 depicts a simplified flowchart for performing rescaling according to some embodiments.

FIG. 4 depicts a simplified flowchart of applying reverse momentum to the update direction according to some embodiments.

FIG. 5 illustrates one example of a computing device according to some embodiments.

### DETAILED DESCRIPTION

Described herein are techniques for a generative model system. In the following description, for purposes of explanation, numerous examples and specific details are set forth to provide a thorough understanding of some embodiments. Some embodiments as defined by the claims may include some or all the features in these examples alone or in combination with other features described below, and may further include modifications and equivalents of the features and concepts described herein.

### System Overview

Classifier-free guidance (CFG) is a type of guidance technique used in generative models, such as diffusion models, that combines the predictions of a conditional model and an unconditional model. Classifier-free guidance modifies a denoiser's output at each sampling step by adding a weighted difference between the conditional and unconditional model predictions. This allows the model to generate high-quality samples while maintaining flexibility. In contrast to classifier-free guidance, classifier guidance refers to a technique used in generative models where a classifier is used to guide the generation process. The classifier provides additional information to the generative model about the desired output, which helps to improve the quality and alignment of the generated samples with the input condition.

Diffusion models are a class of generative models that learn a data distribution by reversing a forward process that adds noise to the data until the samples are indistinguishable from pure noise. Although simulating the backward process in diffusion models should result in correct sampling from the data distribution, unguided sampling from diffusion models often results in low-quality images that do not align well with the input condition (e.g., a prompt). Accordingly, classifier-free guidance increases the quality of generated outputs and increases the alignment between the condition and the generated image, albeit at the cost of reduced diversity. Text-to-image models generally require high guidance scales in order for the generation of output (e.g., images) to have better quality and align well with the input condition. A high guidance scale means that the model is more strongly guided by the conditional model's output compared to the unconditional model's output. However, high guidance scales often result in oversaturated colors and simplified mage compositions.

Conditional diffusion models work by learning to approximate what is known as the conditional score function, which is the gradient with respect to the data of the logarithm of the conditional probability density, p(x|y), where x is the “data” and y is the condition. During inference (sampling), noisy data is denoised by being pushed in the direction of higher probability defined by the score function. Classifier-free guidance works by amplifying the movement in the direction of the conditional score while moving away from the unconditional score. If the system denotes a conditional denoiser output by D(x,y) and an unconditional denoiser output by D(x), then a difference ΔD=D(x,y)−D(x) corresponds to the difference between the conditional and unconditional scores. In classifier-free guidance, some multiple of the difference is added to the conditional denoiser output D(x,y) to prescribe the direction to push the data in. However, the direction of the difference has a component that is parallel to the conditional denoiser output D(x,y) and a component that is orthogonal to the conditional denoiser output D(x,y). The system uses an observation that the orthogonal component is chiefly responsible for the quality-boosting effects of classifier-free guidance, and the parallel component is chiefly responsible for the saturation artifacts. The method underweights the contribution of the parallel component through a parameter.

Accordingly, in some embodiments, a system adjusts an update rule of classifier-free guidance to improve the generation of images. The classifier-free guidance update rule can be decomposed into two components, one that is parallel to the conditional model prediction, and one that is orthogonal to this prediction. The system weights the orthogonal component more strongly than the parallel component. The orthogonal component is mainly responsible for improving image quality, while the parallel component primarily adds contrast and saturation to the output.

Also, in some embodiments, a connection between the classifier-free guidance update rule and stochastic gradient ascent is used to rescale a version of the classifier-free guidance (CFG) update direction. The rescaling may control large updates, which can cause significant drift in the sampling process. To prevent this, the system constrains the updates to lie within a threshold, such as a sphere, or other structure.

Further, in some embodiments, the system incorporates a momentum term. For the momentum term, unlike with traditional optimization, the system may apply a negative value to introduce a repulsive effect between consecutive updates, effectively down-weighting components already present in previous steps. This may be referred to as reverse momentum. By combining rescaling, reverse momentum, and the use of the orthogonal projection, the system uses a method, referred to as adaptive projected guidance (APG), which allows the use of higher guidance scales without oversaturation or degradation in image quality.

### System

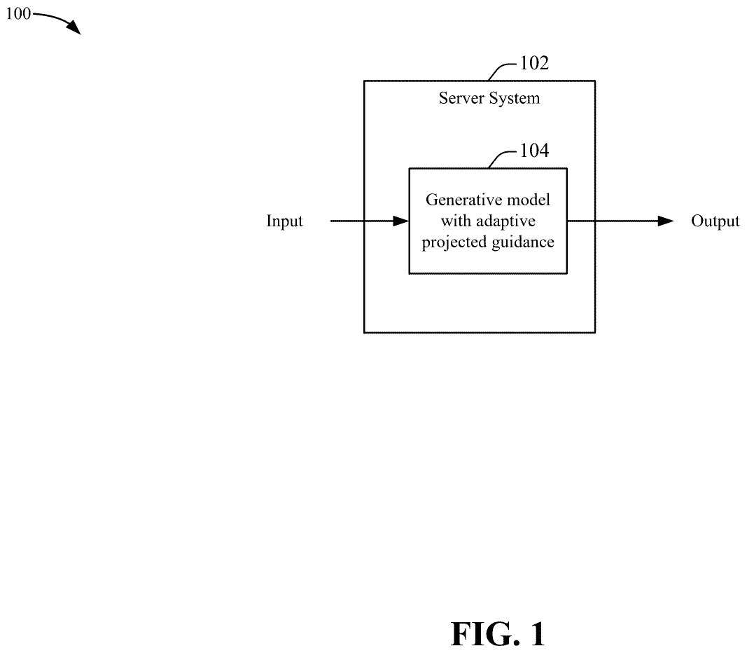

FIG. 1 depicts a simplified system 100 for performing adaptive projected guidance according to some embodiments. A server system 102 includes a generative model 104, such as a diffusion model, that performs adaptive projected guidance. Generative model 104 receives an input, such as text prompts, images, or audio signals, and generates an output. The output may be a perceptual output, such as images, videos, music, etc.

Generative model 104 generates an output by iteratively refining a random noise signal until it converges to a specific data distribution. The process involves a series of transformations that progressively remove noise from the input signal, allowing the model to learn complex patterns and structures within the data. If x˜p_{data}(x) represents a data point, and if zₜ=x+σ(t)ϵ describes a forward process of the diffusion model that introduces noise to the data, where t∈[0, 1] is the time step. Here, zₜ is the noisy version of the input x, and σ(t) is the noise schedule, which determines the amount of information destroyed at each time step t, with σ(0)=0 (e.g., no noise added) and σ(1)=σₘₐₓ. (e.g., the maximum noise added). The forward process may be represented as:

$${dz}_{t} = - \dot{σ} ( t ) σ ( t ) ∇ {z}_{t} log {p}_{t} ( {z}_{t} ) dt , \qquad ( 1 )$$

where pₜ(zₜ) denotes the time-dependent distribution of noisy samples, with p₀=p_{data} and p₁=N(0,

$${σ}_{max}^{2} I ) .$$

With access to the time-dependent score function ∇zₜ log pₜ(zₜ), generative model 104 can sample from the data distribution p_{data} by solving the equation (1) backward in time (from t=1 to t=0). The unknown score function ∇zₜ log pₜ(zₜ) is estimated using a neural denoiser D_{θ}(zₜ, t), which is trained to predict the clean samples x from the corresponding noisy samples zₜ. This framework also allows for conditional generation by training a denoiser D_{θ}(zₜ, t, y) that incorporates additional input signals y, such as class labels or text prompts, as conditions. The conditions may be based on the input that is received to generate the output, and used to guide the conditional process.

Classifier-free guidance is an inference method designed to enhance the quality of generated outputs by combining the predictions of a conditional model and an unconditional model. The input condition y could be additional information that is provided to generative model 104 to guide its output generation. For example, the input condition may be a text prompt, image, or other signals that the model uses to generate the output, such as an image or other type of output. Given a null condition yₙᵤₗₗ=Ø for the unconditional model, classifier-free guidance modifies the denoiser's output at each sampling step as follows:

$${\hat{D}}_{CFG} ( {z}_{t} , t , y ) = {D}_{θ} ( {z}_{t} , t , {y}_{null} ) + w ( {D}_{θ} ( {z}_{t} , t , y ) - {D}_{θ} ( {z}_{t} , t , {y}_{null} ) ) , \qquad ( 2 )$$

where w=1 represents the non-guided case. The output of the denoiser is \hat{D}_{CFG}(zₜ, t, y) for the iteration, the output of the conditional model is D_{θ}(zₜ, t, y), and the output of the unconditional model is D_{θ}(zₜ, t, yₙᵤₗₗ). The unconditional model D_{θ}(zₜ, t, yₙᵤₗₗ) is trained by randomly applying the null condition yₙᵤₗₗ=Ø to the denoiser's input for a portion of training. The use of yₙᵤₗₗ=Ø means that the condition is not applied. Alternatively, a separate denoiser can be trained to estimate the unconditional prediction in Equation (2).

In adaptive projected guidance, there is the unconditional model output D_{θ}(zₜ, t, yₙᵤₗₗ), the conditional model output D_{θ}(zₜ, t, y), and the CFG update direction ΔDₜ=D_{θ}(zₜ, t, y)−D_{θ}(zₜ, t, yₙᵤₗₗ) at time step t. That is, the CFG update direction is a difference between the conditional model output D_{θ}(zₜ, t, y) and the unconditional model output D_{θ}(zₜ, t, yₙᵤₗₗ). The CFG update direction is used by generative model 104 to adjust the conditional model output. Equation 2 can be rewritten as:

$${\hat{D}}_{CFG} ( {z}_{t} , t , y ) = {D}_{θ} ( {z}_{t} , t , y ) + ( w - 1 ) Δ {D}_{t} , \qquad ( 3 )$$

In equation (3), the updated denoiser output \hat{D}_{CFG}(zₜ, t, y) is expressed in terms of the conditional model output D_{θ}(zₜ, t, y), a weighting term (w−1), and the CFG update direction ΔDₜ. Generative model 104 can decompose the CFG update direction ΔDₜ into two different components of the parallel component

$$Δ {D}_{t}^{‖}$$

and the orthogonal component

$$Δ {D}_{t}^{⊥} .$$

The parallel component

$$Δ {D}_{t}^{‖}$$

is determined to be the component of the CFG update direction ΔDₜ that is parallel to the conditional model output D_{θ}(zₜ, t, y) and the orthogonal component ΔDₜ^{⊥} is determined to be the component of the CFG update direction ΔDₜ that is orthogonal to the conditional model output D_{θ}(zₜ, t, y). The parallel component may represent the component of the CFG update direction that is aligned with the conditional output. Thus, the CFG update direction can be represented by:

$$Δ {D}_{t} = Δ {D}_{t}^{⊥} + Δ {D}_{t}^{‖} .$$

In some embodiments, the projection of the parallel component

$$Δ {D}_{t}^{‖}$$

is computed as:

$$Δ {D}_{t}^{‖} = \frac{〈 Δ {D}_{t} , {D}_{θ} ( {z}_{t} , t , y ) 〉}{〈 {D}_{θ} ( {z}_{t} , t , y ) , {D}_{θ} ( {z}_{t} , t , y ) 〉} {D}_{θ} ( {z}_{t} , t , y ) \qquad ( 4 )$$

In equation 4, the inner product [symbol] ΔDₜ, D_{θ}(zₜ, t, y) [symbol] is computed between the CFG update direction ΔDₜ and the conditional output D_{θ}(zₜ, t, y). This inner product measures the similarity between the two vectors. The norm [symbol] D_{θ}(zₜ, t, y), D_{θ}(zₜ, t, y) [symbol] is computed, which represents the magnitude of the current output vector. The parallel component

$$Δ {D}_{t}^{‖}$$

is computed by projecting the CFG update direction ΔDₜ onto the conditional output vector D_{θ}(zₜ, t, y). This is done by multiplying the inner product by the normalized current output vector (e.g., divided by its norm). The inner product measures how much of the CFG update direction ΔDₜ is aligned with the conditional output vector. The norm normalizes the conditional output vector. Although this method of determining the projection that is considered the parallel component is described, other methods may be used.

Model 104 uses an observation that the orthogonal component is chiefly responsible for improvements in image quality, while the parallel component increases saturation. Accordingly, generative model 104 modifies the CFG update direction to weight the orthogonal component with a higher strength than the parallel component. The CFG update direction may be:

$$Δ {D}_{t} ( η ) = Δ {D}_{t}^{⊥} + ηΔ {D}_{t}^{‖} ,$$

wherein η≤1 is a hyperparameter. Note that ΔDₜ(1) is identical to the unmodified CFG update direction. By reducing the strength of the parallel component (e.g., setting n close to zero), this significantly reduces the effect of the parallel component, which reduces saturation and results in more realistic generations of images at higher guidance scales. The intuition behind the saturating effect of the parallel component is helped by thinking of the conditional output D_{θ}(zₜ, t, y) as an image with a typical range of values. When a CFG update direction parallel to this image is added, it serves to create a “gain,” pushing the values toward the extremes of their range. Thus, the parallel component adds saturation to the conditional output D_{θ}(zₜ, t, y) during each inference step, much like multiplying pixel values by a number greater than one. Reducing the strength of the parallel component and leaning more heavily on the orthogonal component significantly attenuates this saturation side effect. This allows generative model 104 to refine its output within the current region, while the orthogonal component ΔDₜ^{⊥} enables exploration of new regions.

### Adaptive Projected Guidance

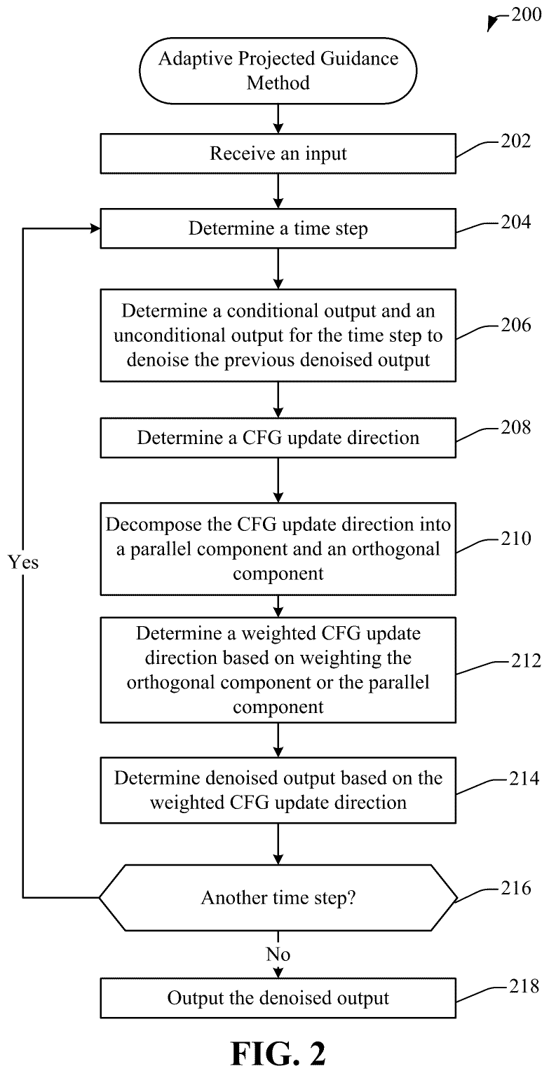

FIG. 2 depicts a simplified flowchart 200 of a method for performing adaptive projected guidance according to some embodiments. At 202, generative model 104 receives an input. The input may be different formats, such as text, audio, or other signals. In some embodiments, the input may be “Generate an image of an elephant”. Here, a user might want generative model 104 to generate an image of the elephant.

At 204, generative model 104 determines a time step t. The time step t may be the number of iterations of denoising that generative model 104 may perform to generate a denoised output of a noisy sample. The denoised output may be an image of the elephant.

At 206, for the time step, generative model 104 determines a conditional output and an unconditional output for denoising the previous denoised output. As mentioned above, generative model 104 may iteratively denoise a noisy sample in multiple iterations. The conditional output may be based on a condition of the input of generating an elephant. The unconditional output may be the prediction that is not based on the input of generating the elephant.

At 208, generative model 104 determines a CFG update direction. The CFG update direction may be the difference between the conditional output and the unconditional output.

At 210, generative model 104 decomposes the CFG update direction into a parallel component and an orthogonal component. The decomposition may determine a projection of the CFG update direction into a parallel component that is parallel to the conditional output and an orthogonal component that is orthogonal to the unconditional output.

At 212, generative model 104 determines a weighted CFG update direction based on weighting the orthogonal component, the parallel component, or both. The weight that is applied may be set, such as via a parameter that is set by user input. The weighting strengthens the orthogonal component compared to the parallel component, and may be performed in different ways.

At 214, generative model 104 determines the denoised output based on the weighted CFG update direction. The denoised output may be a prediction of which noise to remove from a previous denoised output, which is described in equation (3).

At 216, generative model 104 determines if there is another time step. For example, generative model 104 determines if all iterations of denoising have been performed for time step t. If another step needs to be performed, the process reiterates to 204 to determine another time step. The process then continues to determine another denoising output.

When the time steps have been performed, generative model 104 outputs the denoised output. For example, generative model 104 outputs a generated image of an elephant.

The decomposition of the CFG update direction into parallel and orthogonal components, and weighting the components to increase the strength of the orthogonal component improves the generated output. Generative model 104 may also use other techniques to improve the output, such as rescaling and reverse momentum. The following will now describe the use of rescaling and reverse momentum.

### Rescaling

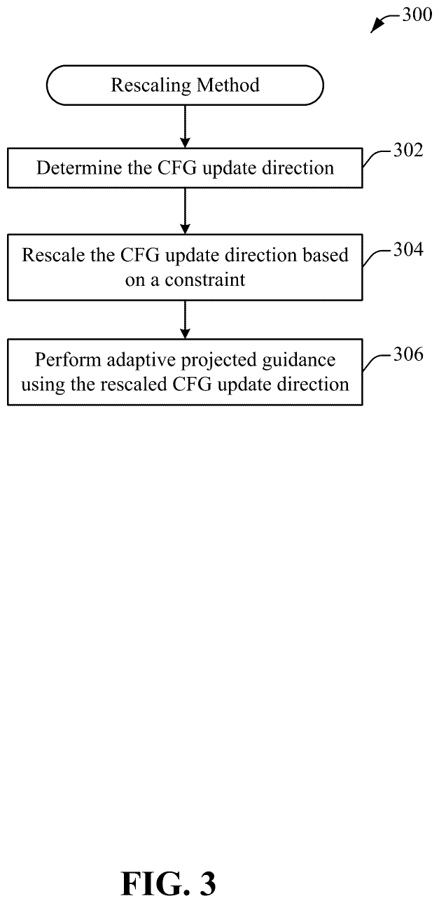

FIG. 3 depicts a simplified flowchart 300 for performing rescaling according to some embodiments. At 302, generative model 104 determines the CFG update direction. The CFG update direction that is determined is for one iteration of the time steps.

At 304, generative model 104 rescales the CFG update direction based on a constraint. The classifier-free guidance update rule in Equation (3) can be interpreted as one step of gradient ascent on the [symbol] 2 distance between the conditional and unconditional prediction, i.e., one step of gradient ascent on ½∥D_{θ}(zₜ, t, y)−D_{θ}(zₜ, t, yₙᵤₗₗ)∥² with a learning rate of w−1. Generative model 104 may rescale the classifier-free guidance update rule at each time step to regulate the impact of each update. In some embodiments, generative model 104 constrains the CFG update direction ΔDₜ with a constraint. The constraint may constrain the CFG update direction ΔDₜ to be inside a structure, such as a sphere, with radius r. Although a sphere is discussed, other constraints and structures may be used. In some embodiments, the following constraint may be used:

$$Δ {D}_{t} ← Δ {D}_{{t}^{′}} min ( 1 , \frac{r}{‖ Δ Dt ‖} ) 1 , \qquad ( 5 )$$

where r is a hyperparameter. This rescaling ensures that the CFG update direction ΔDₜ stays closer to the conditional output D_{θ}(zₜ, t, y), limiting drift at each sampling step if ∥ΔDₜ∥ is large. This limits the drift at each sampling time step if the CFG update direction is large. That is, the constraint does not allow the CFG update direction to be larger than the structure. This may limit over saturation where CFG update directions may be larger than the constraint.

At 306, generative model 104 performs adaptive projected guidance using the rescaled CFG update direction. For example, the direction may be decomposed into a parallel component and an orthogonal component, and weighting is applied to strengthen the orthogonal component as described above.

### Reverse Momentum

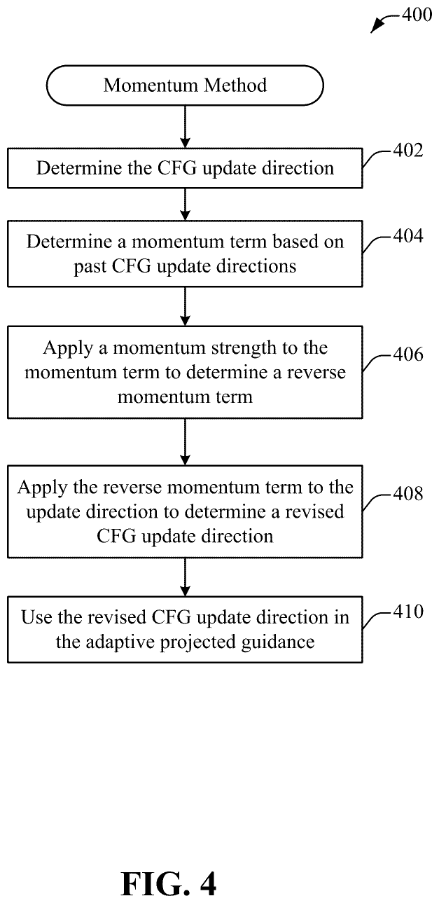

FIG. 4 depicts a simplified flowchart 400 of applying reverse momentum to the CFG update direction according to some embodiments. Leveraging the connection to gradient ascent, generative model 104 introduces a reverse momentum term to the classifier-free guidance update rule.

At 402, generative model 104 determines the CFG update direction. The CFG update direction may be for one iteration of the time steps.

At 404, generative model 104 determines a momentum term based on past CFG update directions. In some embodiments, the momentum term may be the average value of past CFG update directions, but the momentum term may be determined in other ways.

At 406, generative model 104 applies a momentum strength to the momentum term to determine a reverse momentum term. The reverse momentum term may be determined by applying a negative momentum strength to the momentum term. The revised CFG update direction is Δ̅D̅ₜ̅←ΔDₜ+βΔ̅D̅ₜ̅, where Δ̅D̅ₜ̅=0 initially. The momentum term Δ̅D̅ₜ̅ accounts for the average value of past updates; however, instead of using positive momentum, generative model 104 may use a negative momentum strength β<0. This results in a reverse momentum term of βΔ̅D̅ₜ̅. Intuitively, this pushes generative model 104 away from previous CFG update directions and encourages generative model 104 to focus more on the current CFG update direction.

At 408, generative model 104 applies the reverse momentum term to the CFG update direction to determine a revised CFG update direction. The CFG update direction is \sqrt{ΔDₜ} ←ΔDₜ+β̅Δ̅D̅ₜ̅, where the current CFG update direction has the reverse momentum term added to determine the revised CFG update direction Δ̅D̅ₜ̅.

At 410, generative model 104 uses the revised CFG update direction in the adaptive projected guidance.

### Conclusion

Accordingly, adaptive, projected guidance improves the generation of output from a generative model. For example, by separating out the CFG update direction into a parallel component and an orthogonal component, and then weighting the orthogonal component with more strength than the parallel component, images with less oversaturation may result.

### System

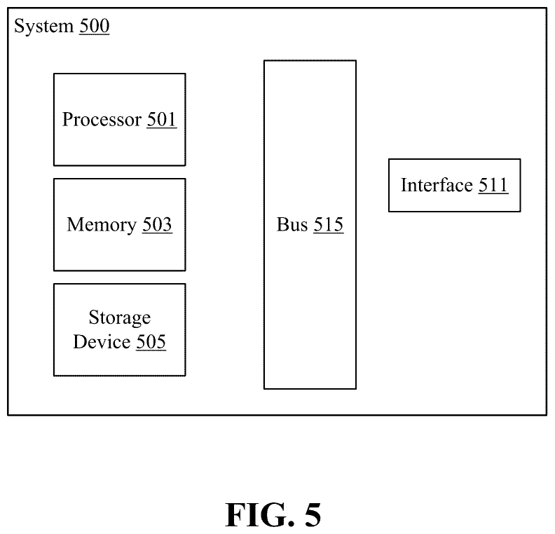

FIG. 5 illustrates one example of a computing device according to some embodiments. According to various embodiments, a system 500 suitable for implementing embodiments described herein includes a processor 501, a memory 503, a storage device 505, an interface 511, and a bus 515 (e.g., a PCI bus or other interconnection fabric.) System 500 may operate as a variety of devices such as generative model 104, or any other device or service described herein. Although a particular configuration is described, a variety of alternative configurations are possible. Processor 501 may perform operations such as those described herein. Instructions for performing such operations may be embodied in memory 503, on one or more non-transitory computer readable media, or on some other storage device. Various specially configured devices can also be used in place of or in addition to processor 501. Memory 503 may be random access memory (RAM) or other dynamic storage devices. Storage device 505 may include a non-transitory computer-readable storage medium holding information, instructions, or some combination thereof, for example instructions that when executed by the processor 501, cause processor 501 to be configured or operable to perform one or more operations of a method as described herein. Bus 515 or other communication components may support communication of information within system 500. The interface 511 may be connected to bus 515 and be configured to send and receive data packets over a network. Examples of supported interfaces include, but are not limited to: Ethernet, fast Ethernet, Gigabit Ethernet, frame relay, cable, digital subscriber line (DSL), token ring, Asynchronous Transfer Mode (ATM), High-Speed Serial Interface (HSSI), and Fiber Distributed Data Interface (FDDI). These interfaces may include ports appropriate for communication with the appropriate media. They may also include an independent processor and/or volatile RAM. A computer system or computing device may include or communicate with a monitor, printer, or other suitable display for providing any of the results mentioned herein to a user.

Any of the disclosed implementations may be embodied in various types of hardware, software, firmware, computer readable media, and combinations thereof. For example, some techniques disclosed herein may be implemented, at least in part, by non-transitory computer-readable media that include program instructions, state information, etc., for configuring a computing system to perform various services and operations described herein. Examples of program instructions include both machine code, such as produced by a compiler, and higher-level code that may be executed via an interpreter. Instructions may be embodied in any suitable language such as, for example, Java, Python, C++, C, HTML, any other markup language, JavaScript, ActiveX, VBScript, or Perl. Examples of non-transitory computer-readable media include, but are not limited to: magnetic media such as hard disks and magnetic tape; optical media such as flash memory, compact disk (CD) or digital versatile disk (DVD); magneto-optical media; and other hardware devices such as read-only memory (“ROM”) devices and random-access memory (“RAM”) devices. A non-transitory computer-readable medium may be any combination of such storage devices.

In the foregoing specification, various techniques and mechanisms may have been described in singular form for clarity. However, it should be noted that some embodiments include multiple iterations of a technique or multiple instantiations of a mechanism unless otherwise noted. For example, a system uses a processor in a variety of contexts but can use multiple processors while remaining within the scope of the present disclosure unless otherwise noted. Similarly, various techniques and mechanisms may have been described as including a connection between two entities. However, a connection does not necessarily mean a direct, unimpeded connection, as a variety of other entities (e.g., bridges, controllers, gateways, etc.) may reside between the two entities.

Some embodiments may be implemented in a non-transitory computer-readable storage medium for use by or in connection with the instruction execution system, apparatus, system, or machine. The computer-readable storage medium contains instructions for controlling a computer system to perform a method described by some embodiments. The computer system may include one or more computing devices. The instructions, when executed by one or more computer processors, may be configured or operable to perform that which is described in some embodiments.

As used in the description herein and throughout the claims that follow, “a”, “an”, and “the” include plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of some embodiments may be implemented. The above examples and embodiments should not be deemed to be the only embodiments and are presented to illustrate the flexibility and advantages of some embodiments as defined by the following claims. Based on the above disclosure and the following claims, other arrangements, embodiments, implementations, and equivalents may be employed without departing from the scope hereof as defined by the claims.

What is claimed is:

1. A method comprising:
determining, by a generative model, a conditional output and an unconditional output for denoising a noisy sample;
determining an update direction based on the conditional output and the unconditional output;
decomposing the update direction into a first component and a second component;
weighting one or more of the first component and the second component to generate a weighted update direction, wherein the weighted update direction is based on reducing a strength of the second component; and
determining a denoised output based on the conditional output and the weighted update direction, wherein the denoised output is used to generate a generative output by the generative model.

2. The method of claim 1, further comprising:
receiving an input to generate the generative output using the generative model.

3. The method of claim 2, wherein the input is used as a condition to generate the conditional output.

4. The method of claim 2, wherein:
the input comprises a prompt to generate an image, and
the generative output is an image that is generated based on the prompt.

5. The method of claim 1, further comprising:
performing multiple iterations of determining denoised outputs to denoise the noisy sample to the generative output.

6. The method of claim 1, wherein:
the conditional output is generated by the generative model using a condition, and
the unconditional output is generated by the generative model without using the condition.

7. The method of claim 1, wherein determining the update direction comprises:
determining a difference between the unconditional output and the conditional output.

8. The method of claim 1, wherein decomposing the update direction into the first component and the second component comprises:
decomposing the update direction into an orthogonal component in a first direction and a parallel component in a second direction.

9. The method of claim 8, wherein:
the orthogonal component is orthogonal to the conditional output, and
the parallel component is parallel to the conditional output.

10. The method of claim 1, wherein decomposing the update direction into the first component and the second component comprises:
determining a first projection of the update direction that is considered orthogonal to the conditional output; and
determining a second projection of the update direction that is considered parallel to the conditional output.

11. The method of claim 1, wherein weighting one or more of the first component and the second component comprises:
reducing a strength of the second component compared to the first component.

12. The method of claim 1, wherein reducing the strength of the second component comprises:
applying a parameter that reduces the strength of the second component to determine a reduced second component, wherein the weighted update direction is based on the first component and the reduced second component.

13. The method of claim 1, wherein determining the denoised output based on the conditional output and the weighted update direction comprises:
adding the weighted update direction to the conditional output to determine the denoised output.

14. The method of claim 13, wherein the denoised output is used to denoise a previously denoised output from a previous iteration.

15. The method of claim 1, further comprising:
rescaling the update direction based on a constraint.

16. The method of claim 15, wherein rescaling the update direction comprises:
reducing the update direction to be within a structure defined by the constraint.

17. The method of claim 1, further comprising:
determining a momentum term based on previous update directions;
applying a negative momentum strength to the momentum term to determine a reverse momentum term; and
determining a revised update direction by applying the reverse momentum term to the update direction, wherein the revised update direction is used to determine the denoised output.

18. A non-transitory computer-readable storage medium having stored thereon computer executable instructions, which when executed by a computing device, cause the computing device to be operable for:
determining, by a generative model, a conditional output and an unconditional output for denoising a noisy sample;
determining an update direction based on the conditional output and the unconditional output;
decomposing the update direction into a first component and a second component;
weighting one or more of the first component and the second component to generate a weighted update direction, wherein the weighted update direction is based on reducing a strength of the second component; and
determining a denoised output based on the conditional output and the weighted update direction, wherein the denoised output is used to generate a generative output by the generative model.

19. The non-transitory computer-readable storage medium of claim 18, wherein an input is used as a condition to generate the conditional output.

20. An apparatus comprising:
one or more computer processors; and
a computer-readable storage medium comprising instructions for controlling the one or more computer processors to be operable for:
determining, by a generative model, a conditional output and an unconditional output for denoising a noisy sample;
determining an update direction based on the conditional output and the unconditional output;
decomposing the update direction into a first component and a second component;
weighting one or more of the first component and the second component to generate a weighted update direction, wherein the weighted update direction is based on reducing a strength of the second component; and
determining a denoised output based on the conditional output and the weighted update direction, wherein the denoised output is used to generate a generative output by the generative model.
